(19) United States
(12) Patent Application Publication
(10) Pub. No.: US 2016/0059642 A1
(43) Pub. Date: Mar. 3, 2016

(54) PNEUMATIC TIRE

(71) Applicant: TOYO TIRE & RUBBER CO., LTD., Osaka (JP)

(72) Inventor: Kazuo Shimomura, Osaka-shi (JP)

(73) Assignee: TOYO TIRE & RUBBER CO., LTD., Osaka (JP)

(21) Appl. No.: 14/834,679

(22) Filed: Aug. 25, 2015

(30) Foreign Application Priority Data
Aug. 26, 2014 (JP) 2014-171423

(51) Int. Cl. B60C 19/08; B60C 11/03

(52) U.S. Cl. CPC B60C 19/082; B60C 11/03

(57) ABSTRACT

In a pneumatic tire, a rubber hardness of a conductive portion is greater than a rubber hardness of a non-conductive portion, the conductive portion is formed from an inner end portion toward an outer end portion in a tire diametrical direction of the land portion by continuing a plurality of inclined portions which are inclined in relation to the tire diametrical direction, and at least one conductive portion is arranged in an outer region which is an outer side at the time of mount to a vehicle, and the inclined portion arranged at an outermost side in the tire diametrical direction is arranged so as to be inclined from an inner side toward an outer side in a tire width direction as the inclined portion goes from an inner side to an outer side in the tire diametrical direction, in the conductive portion arranged in the outer region.

### CROSS REFERENCE TO RELATED APPLICATIONS

This application claims the benefit of priority under 35 USC 119 of Japanese application no. 2014-171423, filed on Aug. 26, 2014, which is incorporated herein by reference.

### BACKGROUND OF THE INVENTION

1. Field of the Invention

The present invention relates to a pneumatic tire having a conductive portion which is formed by a conductive rubber.

2. Description of the Related Art

Conventionally, as the pneumatic tire, there has been known a pneumatic tire having a non-conductive portion which is formed by a non-conductive rubber, and a conductive portion which is formed by a conductive rubber (refer, for example, to JP-A-2008-285070). In the pneumatic tire mentioned above, the conductive portion is formed into a zigzag shape from an inner end portion to an outer end portion in a tire diametrical direction of a tread rubber, by continuing a plurality of inclined portions which are inclined in relation to the tire diametrical direction. In the meantime, a steering stability performance at the turning time is not taken into consideration at all, in the pneumatic tire according to the patent document mentioned above.

### SUMMARY OF THE INVENTION

Accordingly, the present invention is made by taking the circumstance into consideration, and an object of the present invention is to provide a pneumatic tire which improves the steering stability performance.

There is provided a pneumatic tire which includes:

a tread rubber,

the tread rubber having a plurality of main grooves which extend along a tire peripheral direction,

wherein the tread rubber comprises land portions which are partitioned by the main grooves,

wherein the land portion comprises a non-conductive portion which is formed by a non-conductive rubber, and a conductive portion which is formed by a conductive rubber,

wherein a rubber hardness of the conductive portion is greater than a rubber hardness of the non-conductive portion,

wherein the conductive portion is formed from an inner end portion toward an outer end portion in a tire diametrical direction of the land portion by continuing a plurality of inclined portions which are inclined in relation to the tire diametrical direction, and at least one conductive portion is arranged in an outer region which is an outer side at the time of mount to a vehicle, and

wherein the inclined portion arranged at an outermost side in the tire diametrical direction is arranged so as to be inclined from an inner side toward an outer side in a tire width direction as the inclined portion goes from an inner side to an outer side in the tire diametrical direction, in the conductive portion arranged in the outer region.

In the pneumatic tire, the rubber hardness of the conductive portion is greater than the rubber hardness of the non-conductive portion. Further, the conductive portion is provided with a plurality of inclined portions which are inclined in relation to the tire diametrical direction, and is formed from the inner end portion to the outer end portion in the tire diametrical direction of the land portion by connecting the inclined portions. As a result, it is possible to suppress deformation of the land portion having the conductive portion at the turning time.

Further, at least one conductive portion is arranged in the outer region which is the outer side at the time of mount to the vehicle. Further, the inclined portion arranged at the outermost side in the tire diametrical direction is arranged so as to be inclined from the inner side toward the outer side in the tire width direction as the inclined portion goes from the inner side to the outer side in the tire diametrical direction, at the conductive portion arranged in the outer region. As a result, it is possible to further suppress deformation of the land portion having the conductive portion at the turning time, thereby improving the steering stability performance.

Also the pneumatic tire may have a configuration in which:

wherein the inclined portion arranged at an innermost side in the tire diametrical direction is arranged so as to be inclined from the inner side toward the outer side in the tire width direction as the inclined portion goes from the inner side to the outer side in the tire diametrical direction, in the conductive portion arranged in the outer region.

According to the structure mentioned above, the inclined portion arranged at the innermost side in the tire diametrical direction is arranged so as to be inclined from the inner side to the outer side in the tire width direction as the inclined portion goes from the inner side to the outer side in the tire diametrical direction, at the conductive portion arranged in the outer region. As a result, it is possible to effectively suppress the deformation of the land portion having the conductive portion at the turning time, thereby further improving the steering stability performance.

Also the pneumatic tire may have a configuration in which:

wherein the conductive portion is arranged at both sides in the tire width direction of the tread rubber, and

wherein the inclined portion arranged at the outermost side in the tire diametrical direction is arranged so as to be inclined from the inner side toward the outer side in the tire width direction as the inclined portion goes from the inner side to the outer side in the tire diametrical direction, in each of the conductive portions.

According to the structure mentioned above, the conductive portions are arranged at both sides in the tire width direction of the tread rubber. Further, the inclined portion arranged at the outermost side in the tire diametrical direction is arranged so as to be inclined from the inner side to the outer side in the tire width direction as the inclined portion goes from the inner side to the outer side in the tire diametrical direction, at each of the conductive portions.

As a result, whichever direction the tire is mounted to the vehicle, the inclined portion arranged at the outermost side in the tire diametrical direction is arranged so as to be inclined from the inner side to the outer side in the tire width direction as the inclined portion goes from the inner side to the outer side in the tire diametrical direction, at the conductive portion arranged in the outer region which is the outer side at the time of mount to the vehicle. Accordingly, it is possible to suppress the deformation of the land portion having the conductive portion at the turning time, thereby improving the steering stability performance regardless of the direction that the tire is mounted to the vehicle.

Also the pneumatic tire may have a configuration in which:

wherein four main grooves are provided in the tread rubber, and

wherein the conductive portion is arranged at least in the land portion which is adjacent inside in the tire width direction in relation to the main groove arranged at the outermost side at the time of mount to the vehicle, among a plurality of land portions.

As mentioned above, the pneumatic tire according to the present invention achieves an excellent effect that the steering stability performance is improved.

### BRIEF DESCRIPTION OF THE DRAWINGS

FIG. 1 is a cross sectional view of a substantial part which is cut along a tire diametrical direction of a pneumatic tire according to an embodiment;

FIG. 2 is an enlarged view of a region II in FIG. 1 of the pneumatic tire according to the embodiment;

FIG. 3 is an enlarged view of the region II in FIG. 1 of the pneumatic tire according to the embodiment, and is a view for describing a manufacturing method;

FIG. 4 is a cross sectional view of a substantial part which is cut along the tire diametrical direction of the pneumatic tire according to the embodiment, and is a view showing a state at the straight traveling time;

FIG. 5 is a cross sectional view of a substantial part which is cut along the tire diametrical direction of the pneumatic tire according to the embodiment, and is a view showing a state of a front outer wheel at the turning time;

FIG. 6 is an enlarged cross sectional view of a substantial part which is cut along a tire diametrical direction of a pneumatic tire according to the other embodiment;

FIG. 7 is an enlarged cross sectional view of a substantial part which is cut along a tire diametrical direction of a pneumatic tire according to further the other embodiment;

FIG. 8 is an enlarged cross sectional view of a substantial part which is cut along a tire diametrical direction of a pneumatic tire according to further the other embodiment;

FIG. 9 is an enlarged cross sectional view of a substantial part which is cut along a tire diametrical direction of a pneumatic tire according to further the other embodiment;

FIG. 10 is an enlarged cross sectional view of a substantial part which is cut along a tire diametrical direction of a pneumatic tire according to a comparative example;

FIG. 11 is an enlarged cross sectional view of a substantial part which is cut along a tire diametrical direction of a pneumatic tire according to the other comparative example; and

FIG. 12 is a table of evaluation of examples and the comparative examples.

### DETAILED DESCRIPTION OF THE PREFERRED EMBODIMENTS

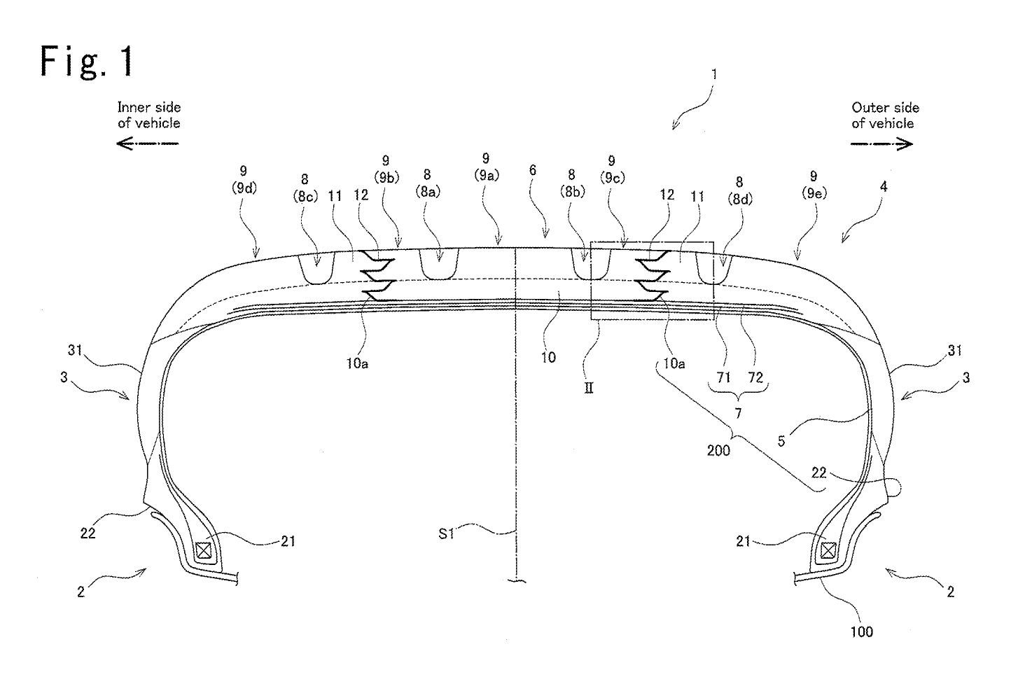

A description will be given below of an embodiment in a pneumatic tire with reference to FIGS. 1 to 5. In each of the drawings (same applied to FIGS. 6 to 11), a dimensional ratio of the drawing and an actual dimensional ratio do not necessarily coincide with each other.

As shown in FIG. 1, a pneumatic tire (hereinafter, refer simply to as “tire”) 1 according to the present embodiment is provided with a pair of bead portions 2 and 2 each having a bead 21. Further, the tire 1 is provided with side wall portions 3 and 3 which extend to outer sides in a tire diametrical direction from the respective bead portions 2, and a tread portion 4 which is connected to outer side ends in the tire diametrical direction of a pair of side wall portions 3 and 3 and constructs a ground surface.

The tread portion 4 is provided with a tread rubber 6 which is arranged at an outer peripheral side of a carcass layer 5 so as to construct the ground surface (the tread surface) coming into contact with the ground surface. Further, the tread portion 4 is provided with a belt layer 7 which is arranged at an outer peripheral side of the carcass layer and in an inner peripheral side of the tread rubber 6 so as to reinforce the carcass layer 5.

The tire 1 is provided with the carcass layer 5 which is bridged between a pair of beads 21 and 21 and is wound up from an inner side to an outer side in the tire width direction so as to enclose the bead 21. Further, the tire 1 is mounted to a rim 100. In the present embodiment, the tire 1 is structured such as to be symmetrical to a tire equatorial plan S1 which is a virtual surface passing through a center in the tire width direction.

The bead portion 2 is provided with a rim strip rubber 22 which is arranged at the outer side in the tire width direction of the carcass layer 5. The strip rubber 22 comes into contact with the rim 100 when the tire 1 is mounted to the rim 100.

The side wall portion 3 is provided with a side wall rubber 31 which is arranged at the outer side in the tire width direction of the carcass layer 5. The side wall rubber 31 is connected to the tread rubber 6 in the outer side in the tire diametrical direction, and is connected to the rim strip rubber 22 in the inner side in the tire diametrical direction.

The carcass layer 5 is constructed by one carcass ply. Further, the carcass ply is formed by coating a ply cord (for example, a steel cord, and an organic fiber cord) arranged in a direction which is approximately orthogonal to the tire peripheral direction, with a topping rubber.

The belt layer 7 is constructed by at least two layers of belt plies (two layers of belt plies in the present embodiment) 71 and 72. Each of the belt plies 71 and 72 is formed by coating a plurality of belt cords (for example, the steel cords and the organic fiber cords) arranged in parallel, with the topping rubber. Each of the belt plies 71 and 72 is laminated so that the cords arranged at a predetermined angle of inclination (for example, between 15 degrees and 35 degrees) in relation to the tire peripheral direction inversely intersect with each other between the plies.

The tread rubber 6 is provided with a plurality of main grooves 8 which extend along the tire peripheral direction. Further, the tread rubber 6 is provided with a plurality of land portions 9 which are partitioned by a plurality of main grooves 8. Further, the tread rubber 6 is provided with a tread bottom portion 10 which is arranged at an inner peripheral side of the main grooves 8 and the land portions 9. In other words, the land portions 9 protrude toward an outer side in the tire diametrical direction from the tread bottom portion 10.

In the present embodiment, four main grooves 8 are provided in the tread rubber 6. The main grooves 8 which are adjacent in relation to the tire equatorial plan S1 are called center main grooves 8a and 8b, and the main grooves 8 which are arranged at the outer side in the tire width direction from the center main grooves 8a and 8b are called shoulder main grooves 8c and 8d.

Further, five land portions 9 are provided by being partitioned by four main grooves 8. The land portion 9 arranged between the center main grooves 8a and 8b is called a center land portion 9a, the land portions 9 arranged between the center main grooves 8a and 8b and the shoulder main grooves 8c and 8d are called mediate land portions 9b and 9c, and the land portions 9 arranged at the outer side in the tire width direction from the shoulder main grooves 8c and 8d is called shoulder land portions 9d and 9e.

The main groove 8 is a so-called straight main groove which is formed linearly so as to be parallel to the tire peripheral direction. Further, the main groove 8 is provided with a so-called tread wear indicator (not shown) which is partly shallower in a groove so that a degree of wear can be grasped when the main groove 8 is uncovered as it is worn.

The land portion 9 is provided with a non-conductive portion 11 which is formed by a non-conductive rubber, and a conductive portion 12 which is formed by a conductive rubber. The tire 1 is provided with a conductive route portion 200 which electrically connects the conductive portion 12 and the rim 100 when the tire 1 is mounted to the rim 100.

In the present embodiment, the topping rubber of each of the belt plies 71 and 72 in the belt layer 7, the topping rubber of the carcass layer 5, and the rim strip rubber 22 are formed by the conductive rubber. Further, the conductive route portion 200 has, in the tread bottom portion 10, a connection portion 10a which is formed by the conductive rubber and electrically connects the belt layer 7 and the conductive portion 12.

Further, the conductive route portion 200 is constructed by the connection portion 10a, the belt layer 7, the carcass layer 5 and the rim strip rubber 22 so as to electrically connect the conductive portion 12 and the rim 100. The conductive route portion 200 is not limited to the structure mentioned above, but may be structured such as to electrically connect the conductive portion 12 and the rim 100.

One conductive portion 12 is arranged in an outer region which is located at an outer side at the time of mount to the vehicle. In the present embodiment, the conductive portion 12 is arranged at the main groove 8 arranged at the outermost side at the time of mount to the vehicle, that is, the land portions 9 which are adjacent to each other inside in the tire width direction in relation to the main groove 8 arranged at the outermost side at the time of mount to the vehicle, that is, the shoulder main groove 8d in the outer side at the time of mount to the vehicle. Further, the conductive portions 12 are also provided in the mediate land portion 9b in the inner side at the time of mount to the vehicle, so as to be arranged respectively in both sides in the tire width direction of the tread rubber 6.

Here, the conductive rubber is exemplified by a rubber in which a volume resistivity indicates less than 10⁸ Ω·cm, and is manufactured, for example, by blending a raw material rubber with a carbon black serving as a reinforcing agent at a high rate. The conductive rubber can be obtained by blending with a carbon type known conductivity application material such as a carbon fiber and a graphite, and a metal type known conductivity application material such as a metal powder, a metal oxide, a metal flake and a metal fiber, in addition to the carbon black.

Further, the non-conductive rubber is exemplified by a rubber in which a volume resistivity indicates 10⁸ Ω·cm or more, and is exemplified by a structure obtained by blending a raw material rubber with a silica serving as a reinforcing agent at a high rate. The silica is blended, for example, at 30 to 100 parts by weight in relation to 100 parts by weight of the raw material rubber component. A wet type silica is listed up as the silica, but any materials which are used generally as the reinforcing material can be used with no limitation. The non-conductive rubber may be manufactured by blending burned clay, hard clay and calcium carbonate in addition to the silica such as precipitated silica, and anhydrous silicic acid.

A natural rubber, a styrene butadiene rubber (SBR), a butadiene rubber (BR), an isoprene rubber (IR) and an isobutylene-isoprene rubber (IIR) can be listed up as the raw material rubber mentioned above, and they are used independently used or used by mixing two or more. The raw material rubber mentioned above is appropriately blended with a vulcanizing agent, a vulcanization accelerator, a plasticizer or an antioxidant.

In the conductive rubber forming the conductive portion 12, it is desirable that nitrogen adsorption specific surface area: N2SA (m2/g)×combination amount (mass %) of carbon black is equal to or more than 1900, and preferably equal to or more than 2000, and dibutyl phthalate oil absorption: DBP (ml/100 g)×combination amount (mass %) of carbon black is equal to or more than 1500 and preferably equal to or more than 1700, in the light of improvement of a current-carrying performance obtained by enhancing a durability. N₂SA is determined on the basis of ASTM D3037-89, and DBM is determined on the basis of ASTM D2414-90.

The rubber hardness of the conductive portion 12 is greater than the rubber hardness of the non-conductive portion 11. In the present embodiment, the hardness of the non-conductive rubber in the non-conductive portion 11 is between 62 degrees and 75 degrees, and the rubber harness of the conductive portion 12 is between 65 degrees and 78 degrees.

The rubber hardness is a rubber hardness which is measured at 25° C. by a durometer hardness tester (type A) of JISK6253.

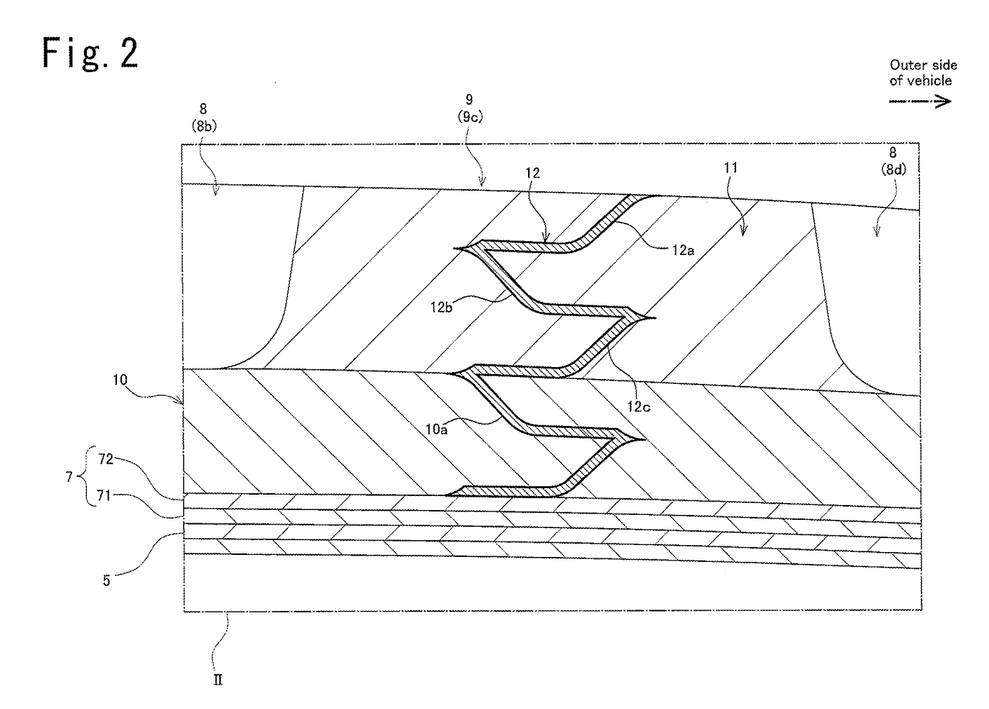

The conductive portion 12 is provided with a plurality of inclined portions 12a to 12c which are inclined in relation to the tire diametrical direction, as shown in FIGS. 1 and 2. Further, the conductive portion 12 is formed from the inner end portion in the tire diametrical direction of the land portion 9 to the outer end portion by continuing a plurality of inclined portions 12a to 12c. Specifically, the conductive portion 12 is formed into a zigzag shape.

In the present embodiment, three inclined portions 12a to 12c are provided. The inclined portion 12a arranged at the outermost side in the tire diametrical direction is called a first inclined portion 12a, the inclined portion 12b arranged at the midpoint of the tire diametrical direction is called a second inclined portion 12b, and the inclined portion 12c arranged at the innermost side in the tire diametrical direction is called a third inclined portion 12c. Each of the inclined portions 12a to 12c is formed into a gentle curved shape.

In each of the conductive portions 12, the first inclined portion 12a arranged at the outermost side in the tire diametrical direction is arranged so as to be inclined from the inner side toward the outer side in the tire width direction as the inclined portion 12a goes from the inner side to the outer side in the tire diametrical direction. Further, in each of the conductive portions 12, the third inclined portion 12c arranged at the innermost side in the tire diametrical direction is arranged so as to be inclined from the inner side toward the outer side in the tire width direction as the inclined portion 12c goes from the inner side to the outer side in the tire diametrical direction.

Further, in each of the conductive portions 12, the second inclined portion 12b arranged at the middle of the tire diametrical direction is arranged so as to be inclined from the outer side toward the inner side in the tire width direction as the inclined portion 12b goes from the inner side to the outer side in the tire diametrical direction. In the present embodiment, a pair of conductive portions 12 are arranged at positions which are symmetrical in relation to the tire equatorial plan S1. Further, a pair of conductive portions 12 are formed so that a direction of inclination of each of the inclined portions 12a to 12c is symmetrical in relation to the tire equatorial plan S1.

The structure of the tire 1 according to the present embodiment is as mentioned above, and a description will be next given of a manufacturing method of the tire 1 according to the present embodiment. Since the tire 1 according to the present embodiment can be manufactured approximately in the same manner as the conventional tire manufacturing steps except a point relating to the tread rubber 6, a description will be given only of a forming step of the tread rubber 6.

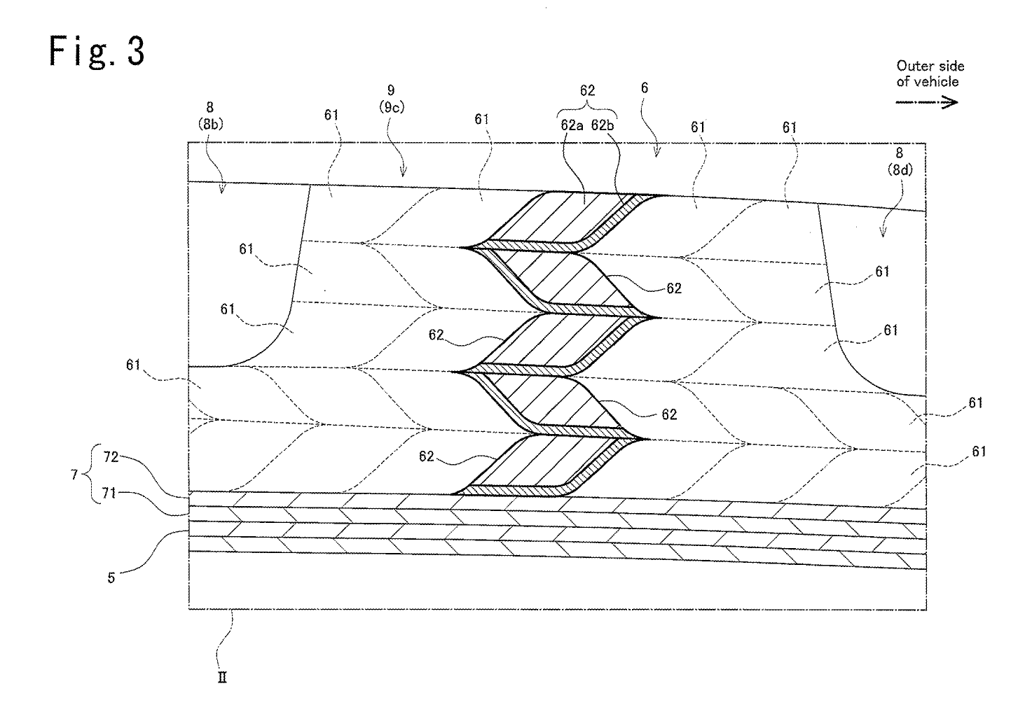

As shown in FIG. 3, a rubber member having a desired cross sectional shape is formed by winding up spirally rubber ribbons 61 and 62 which have small widths and are not vulcanized, in a tire peripheral direction. Specifically, a first rubber ribbon 61 and a second rubber ribbon 62 are wound up spirally in the tire peripheral direction. The first rubber ribbon 61 is constructed by a non-conductive rubber which is approximately triangular shape in its cross section. The second rubber ribbon 62 has a non-conductive rubber 62a which is approximately formed into a triangular shape in its cross section and a conductive rubber 62b which is obtained by coating one side of the non-conductive rubber 62a.

Further, since each of the rubber ribbons 61 and 62 is wound at a predetermined position, the conductive rubber 62b is arranged so that the conductive portion 12 is formed into a zigzag shape from the inner end portion toward the outer end portion in the tire diametrical direction of the land portion 9. In FIG. 3, the first rubber ribbon 61 is shown by a broken line and the second rubber ribbon 62 is shown by a solid line. Further, a tread pattern is formed in an outer surface of the tread rubber 6 by application of vulcanization process.

Since the rubber ribbons 61 and 62 are wound spirally in the tire peripheral direction and are pressed each other, and are thereafter vulcanized, the cross sectional shapes of the rubber ribbons 61 and 62 which are approximately formed into the triangular shaped before being wound, are changed into approximately parallelogram shapes. The cross sectional shapes of the rubber ribbons 61 and 62 are not limited to the structures which are approximately formed into the triangular shapes, but may employ structures which are approximately formed into quadrangular shapes (rectangular shapes, square shapes, parallelogram shapes and trapezoidal shapes) and oval shapes. Further, the manufacturing method of the tire 1 is not limited to the method using the rubber ribbons 61 and 62, but may employ a method using a rubber sheet.

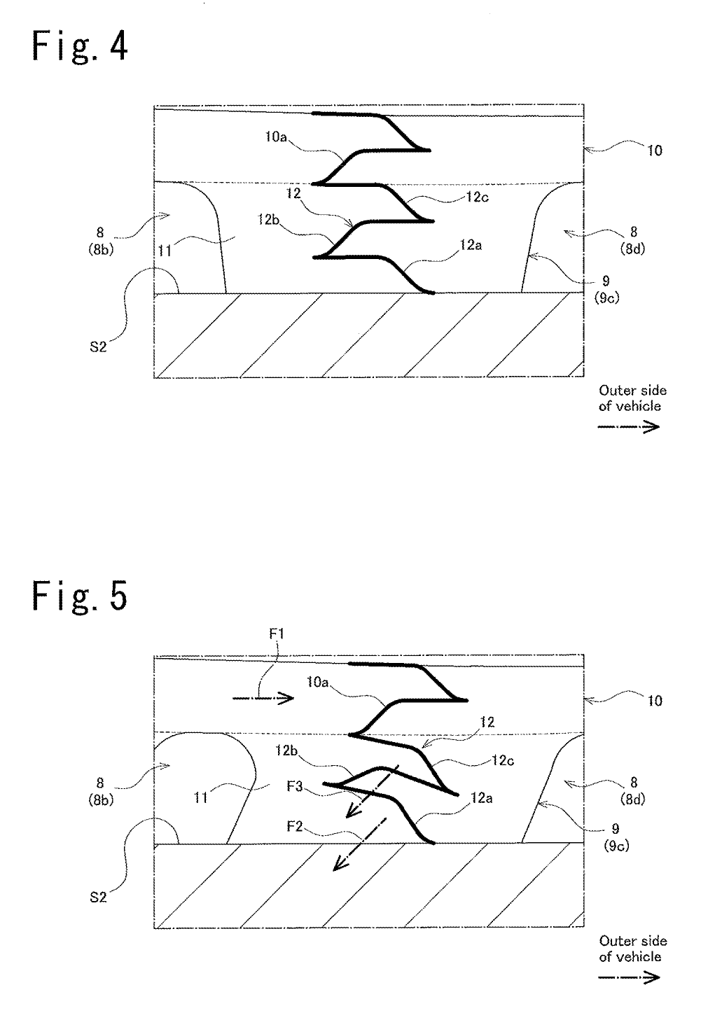

Next, a description will be given of an operation of the tire 1 according to the present embodiment with reference to FIGS. 4 and 5.

A description will be given of the tire 1 which is mounted to the rim 100 which is front and right side in relation to the vehicle having four wheels. First of all, when the vehicle travels straight on the road surface S2, the tire 1 is somewhat deformed due to the vehicle load (FIG. 4 shows while ignoring somewhat deformation) as shown in FIG. 4, but is hardly deformed in the tire width direction.

Further, when the forward traveling vehicle turns in a left direction, the tire 1 corresponding to the outer wheel is greatly deformed in the tire width direction as shown in FIG. 5. More specifically, since the tire 1 receives the force F toward the vehicle outer side, the land portion 9c is deformed so as to be inclined from the vehicle outer side to the vehicle inner side in the tire width direction (from the right to the left in FIG. 5) as the land portion 9c goes from the inner side to the outer side in the tire diametrical direction (from the up to the bottom in FIG. 5).

At this time, the first inclined portion 12a which is most affected by the deformation is arranged so as to be inclined from the inner side toward the outer side in the tire width direction (from the left to the right in FIG. 5) as the inclined portion 12a goes from the inner side to the outer side in the tire diametrical direction (from the top to the bottom in FIG. 5). Therefore, the first inclined portion 12a applies a force which intends to restore from the deformed state (or a force which intends to stand against the deformation) F2. As a result, the deformation of the land portion 9c is suppressed.

Further, the third inclined portion 12c which can most apply the force to the tread bottom portion 10 is arranged so as to be inclined from the inner side toward the outer side in the tire width direction (from the left to the right in FIG. 5) as the inclined portion 12c goes from the inner side to the outer side in the tire diametrical direction (from the up to the bottom in FIG. 5). Therefore, the third inclined portion 12c applies a force which is going to restore from the deformed state (or a force which is going to stand against the deformation) F3. As a result, the deformation of the land portion 9c is suppressed.

In the meantime, it is necessary to suppress the deformation of the land portion 9 in order to improve a cornering power. Further, the portion which is most effective for improving the cornering power is a portion which is near the ground surface (the tread surface) grounding on the road surface, that is, a portion which is near the outermost side in the tire diametrical direction, in the land portion 9, and the portion which is secondly effective is a portion which is near the innermost side in the tire diametrical direction, in the land portion 9.

Therefore, in the present embodiment, since it is possible to suppress the deformation in the most effective portion and the secondly effective portion in the land portion 9, it is possible to effectively improve the cornering power. As a result, it is possible to effectively improve the steering stability performance.

As mentioned above, on the basis of the tire 1 according to the present embodiment, the rubber hardness of the conductive portion 12 is greater than the rubber hardness of the non-conductive portion 11. Further, the conductive portion 12 is provided with a plurality of inclined portions 12a to 12c which are inclined in relation to the tire diametrical direction, and is formed from the inner end portion to the outer end portion in the tire diametrical direction of the land portion 9c by continuing the inclined portions 12a to 12c. As a result, it is possible to suppress the deformation of the land portion 9c having the conductive portion 12 at the turning time.

Further, the conductive portion 12 is arranged in an outer region which is an outer side at the time of mount to the vehicle (the mediate land portion 9c in the outer side of the vehicle). Further, in the conductive portion 12 arranged in the outer region, the first inclined portion 12a arranged at the outermost side in the tire diametrical direction is arranged so as to be inclined from the inner side toward the outer side in the tire width direction as the inclined portion 12a goes from the inner side to the outer side in the tire diametrical direction. As a result, it is possible to further suppress the deformation of the land portion 9c having the conductive portion 12 at the turning time, thereby improving the steering stability performance.

Further, in the tire 1 according to the present embodiment, at the conductive portion 12 arranged in the outer region (the mediate land portion 9c in the outer side of the vehicle), the third inclined portion 12c arranged at the innermost side in the tire diametrical direction is arranged so as to be inclined from the inner side toward the outer side in the tire width direction as the inclined portion 12c goes from the inner side to the outer side in the tire diametrical direction. As a result, it is possible to effectively suppress the deformation of the land portion 9c having the conductive portion 12 at the turning time, thereby further improving the steering stability performance.

Further, in the tire 1 according to the present embodiment, the conductive portion 12 is arranged at each of the land portions 9b and 9c at both sides in the tire width direction of the tread rubber 6. Further, in each of the conductive portions 12, the first inclined portion 12a arranged at the outermost side in the tire diametrical direction is arranged so as to be inclined from the inner side toward the outer side in the tire width direction as the conductive portion 12a goes from the inner side to the outer side in the tire diametrical direction.

As a result, the first inclined portion 12a arranged at the outermost side in the tire diametrical direction is arranged so as to be inclined from the inner side toward the outer side in the tire width direction as the inclined portion 12a goes from the inner side to the outer side in the tire diametrical direction, in the conductive portion 12 arranged in the outer region which is the outer side at the time of mount to the vehicle (the mediate land portion 9c arranged at the outer side of the vehicle) whichever direction the tire is mounted to the vehicle. As a result, it is possible to suppress the deformation of the land portion 9c having the conductive portion 12 at the turning time, thereby improving the steering stability performance regardless of the direction in which the tire is mounted to the vehicle.

The pneumatic tire is not limited to the configuration of the embodiment described above, and the effects are not limited to those described above. It goes without saying that the pneumatic tire can be variously modified without departing from the scope of the subject matter of the present invention. Not to mention, the configurations and methods or the like according to various modification examples described below, for example, may be freely selected and adopted to the configurations or methods of the embodiment described above.

In the tire 1 according to the embodiment, the third inclined portion 12c arranged at the innermost side in the tire diametrical direction is structured such as to be arranged so as to be inclined from the inner side toward the outer side in the tire width direction as the inclined portion 12c goes from the inner side to the outer side in the tire diametrical direction, in the conductive portion 12 arranged at the mediate land portion 9c which is the outer side of the vehicle corresponding to the outer region. However, the tire is not limited to the structure mentioned above. For example, in the tire, the inclined portion 12b arranged at the innermost side in the tire diametrical direction may be structured such as to be arranged so as to inclined from the outer side toward the inner side in the tire width direction as the inclined portion 12b goes from the inner side to the outer side in the tire diametrical direction, as shown in FIG. 6.

Further, in the tire 1 according to the embodiment mentioned above, the conductive portion 12 is structured such as to be provided with three inclined portions 12a to 12c. However, the tire is not limited to the structure mentioned above. For example, in the tire, the conductive portion 12 may be structured such as to be provided with four or more inclined portions. Further, as shown in FIG. 6, the conductive portion 12 may be structured such as to be provided with two inclined portions 12a and 12b.

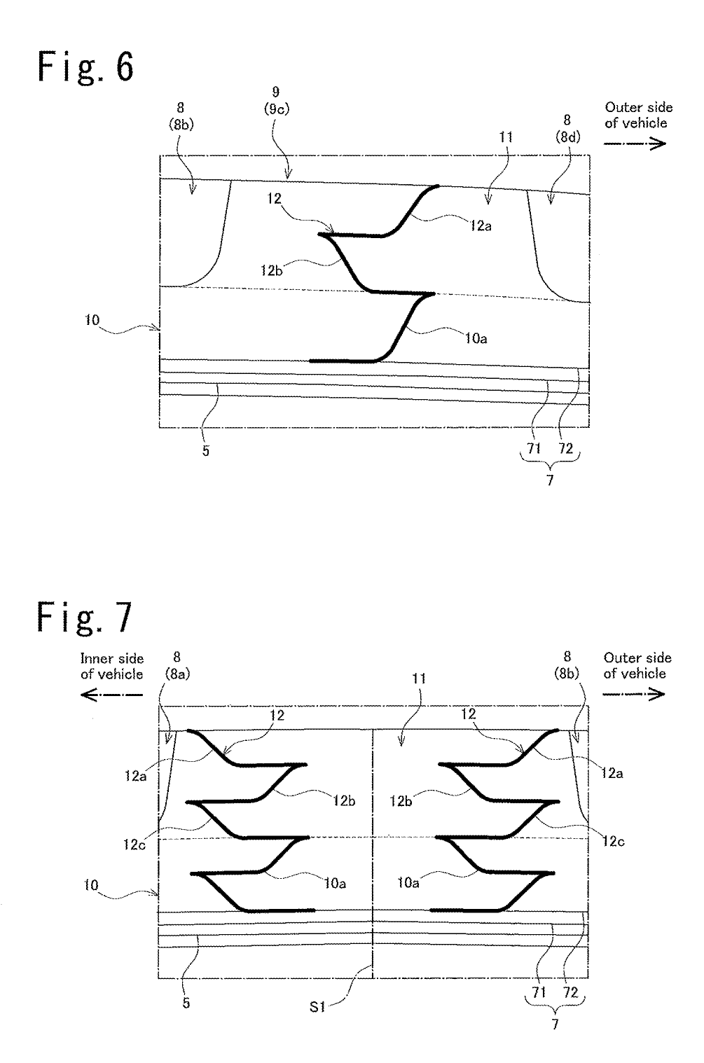

Further, in the tire according to the embodiment mentioned above, the conductive portion 12 is structured such as to be arranged at the mediate land portions 9b and 9c. However, the tire is not limited to the structure mentioned above. For example, in the tire, the conductive portion 12 may be structured such as to be arranged at the shoulder land portions 9d and 9e, or may be structured, as shown in FIG. 7, such as to be arranged at the center land portion 9a, more particularly, at each of both sides of the center land portion 9a.

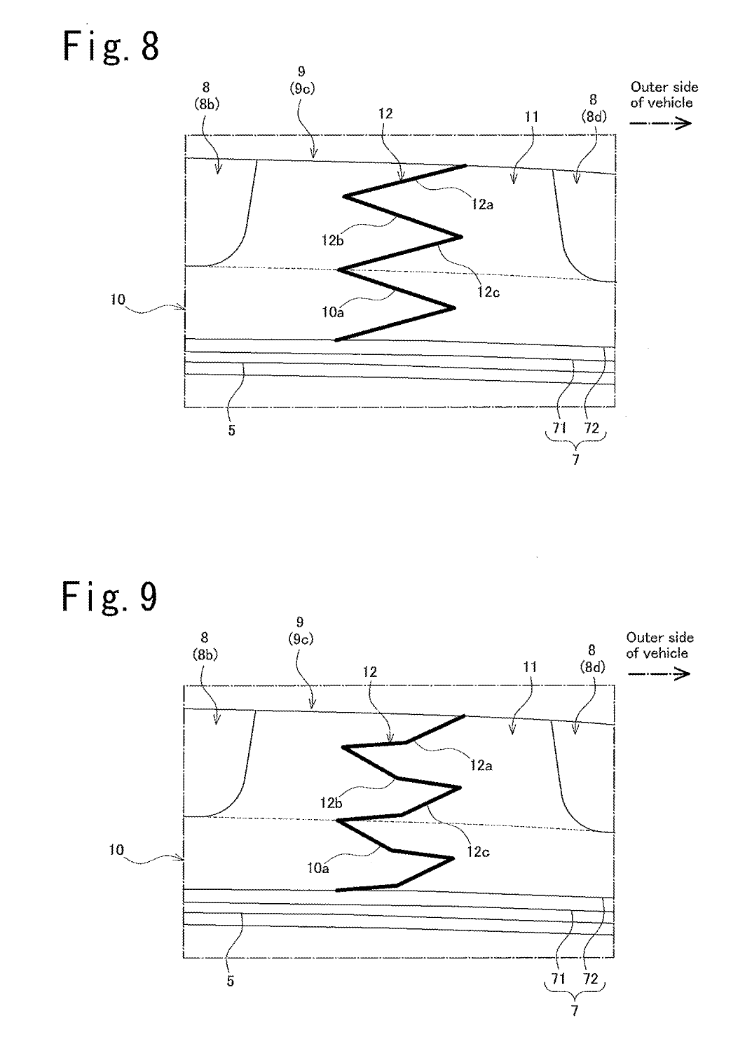

Further, in the tire 1 according to the embodiment mentioned above, the inclined portions 12a to 12c are structured such as to be formed into the curved shape. However, the tire is not limited to the structure mentioned above. For example, in the tire, the inclined portions 12a to 12c may be structured, as shown in FIG. 8, such as to be formed into a linear shape, or may be structured, as shown in FIG. 9, such as to be formed so that two straight lines intersect with each other at obtuse angles (formed into a linear shape which is bent at obtuse angles).

Further, the tire 1 according to the embodiment mentioned above is structured such that a pair of conductive portions 12 are arranged at positions which are symmetrical in relation to the tire equatorial plan S1, and the direction of inclination of each of the inclined portions 12a to 12c is formed so as to be symmetrical in relation to the tire equatorial plan S1. However, the tire is not limited to the structure mentioned above. For example, in the tire, the conductive portion 12 may be structured such as to be arranged only in the outer region which is the outer side at the time of mount to the vehicle.

In short, in the tire, as long as at least one conductive portion 12 is arranged in the outer region which is the outer side at the time of mount to the vehicle, and the inclined portion 12a arranged at the outermost side in the tire diametrical direction is arranged so as to be inclined from the inner side toward the outer side in the tire width direction as the inclined portion 12a goes from the inner side to the outer side in the tire diametrical direction, in the conductive portion 12 arranged in the outer region.

In the case that the tire 1 is structured such as to be asymmetrical in relation to the equatorial plan S1, the tire 1 is a tire in which an mounting direction to the vehicle is designated, and which of right and left sides of the tire is faced to the vehicle is designated when the tire 1 is mounted to the rim 100. In the structure mentioned above, the mounting direction to the vehicle is displayed in the side wall portion 3. More specifically, the side wall portion 3 has a display portion on a surface of the side wall rubber 31 arranged at the outer side in the tire width direction of the carcass layer 5 so as to construct a tire outer surface.

For example, one side wall portion 3 arranged at the inner side at the time of mount to the vehicle (the vehicle inner side) has a display (for example, “INSIDE”) which indicates the vehicle inner side, and the other side wall portion 3 arranged at the outer side at the time of mount to the vehicle (the vehicle outer side) has a display (for example, “OUTSIDE”) which indicates the vehicle outer side.

### EXAMPLES

In order to specifically show the structures and the effects of the tire, a description will be given below of examples and comparative examples of the pneumatic tire with reference to FIG. 12.

### <Steering Stability Performance>

Each of tires having a size 195/65R15 was mounted to a vehicle, and turning travel on a dry road surface was executed. Further, the steering stability performance was evaluated on the basis of a feeling test by a driver. The steering stability performance is indicated by an index number on the assumption that a result of a comparative example 1 is 100. The greater numerical value indicates the more excellent steering stability performance.

### Example 1

An example 1 is a tire according to the embodiment shown in FIGS. 1 to 5. Specifically, the tire is as follows.
Number of inclined portions of a conductive portion in a land portion: three
Direction of inclination of an inclined portion arranged at an outermost side in a tire diametrical direction: inclined from an inner side toward an outer side in a tire width direction as the inclined portion goes from an inner side to an outer side in a tire diametrical direction
Direction of inclination of an inclined portion arranged at an innermost side in the tire diametrical direction: inclined from the inner side toward the outer side in the tire width direction as the inclined portion goes from the inner side to the outer side in the tire diametrical direction
Land portion where conductive portions are arranged: both mediate land portions 9b and 9c

### Example 2

As shown in FIG. 6, an example 2 is a tire which is different from the tire according to the example 1 in the number of the inclined portions and the direction of inclination of the inclined portion arranged at the innermost side. Specifically, the tire is as follows.
Number of inclined portions of a conductive portion in a land portion: two
Direction of inclination of an inclined portion arranged at an outermost side in a tire diametrical direction: same as the example 1
Direction of inclination of an inclined portion arranged at an innermost side in the tire diametrical direction: inclined from the outer side toward the inner side in the tire width direction as the inclined portion goes from the inner side to the outer side in the tire diametrical direction
Land portion where conductive portions are arranged: same as the example 1

### Example 3

As shown in FIG. 7, an example 3 is a tire which is different from the tire according to the example 1 in the land portion where the conductive portion is arranged. Specifically, the tire is as follows.
Number of inclination portions of a conductive portion in a land portion: same as the example 1
Direction of inclination of an inclined portion arranged at an outermost side in a tire diametrical direction: same as the example 1
Direction of inclination of an inclined portion arranged at an innermost side in a tire diametrical direction: same as the example 1
Land portion where conductive portions are arranged: both sides of a center land portion 9a

### Comparative Example 1

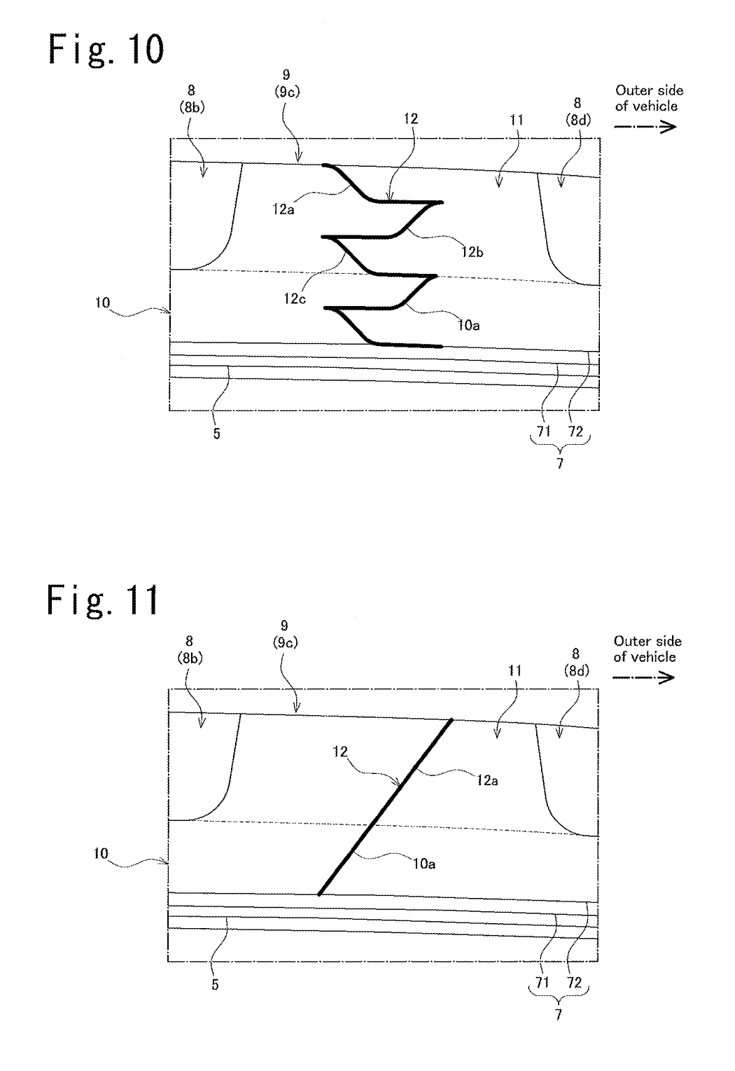

As shown in FIG. 10, a comparative example 1 is a tire which is different from the tire according to the example 1 in the direction of inclination of the inclined portion arranged at the outermost side, and the direction of inclination of the inclined portion arranged at the innermost side. Specifically, the tire is as follows.
Number of inclined portions of a conductive portion in a land portion: same as the example 1
Direction of inclination of an inclined portion arranged at an outermost side in a tire diametrical direction: inclined from an outer side toward an inner side in a tire width direction as the inclined portion goes from an inner side to an outer side in a tire diametrical direction
Direction of inclination of an inclined portion arranged at an innermost side in the tire diametrical direction: inclined from the inner side toward the outer side in the tire width direction as the inclined portion goes from the inner side to the outer side in the tire diametrical direction
Land portion where conductive portions are arranged: same as the example 1

### Comparative Example 2

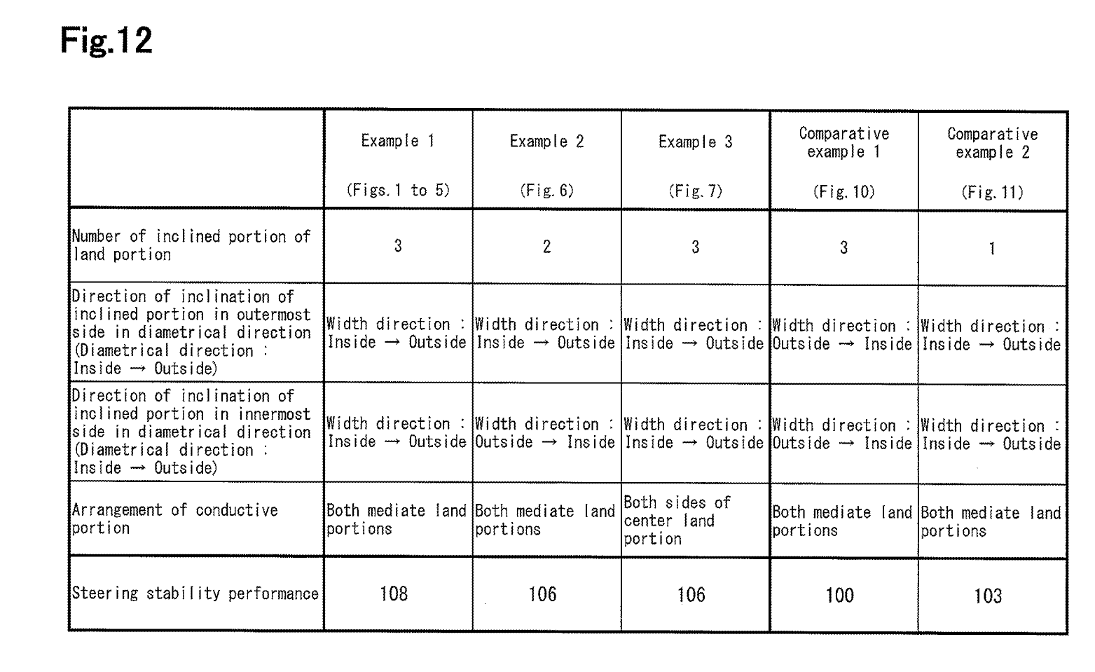

As shown in FIG. 11, a comparative example 2 is a tire which is different from the tire according to the example 1 in the number of the inclined portions of the conductive portion in the land portion. Specifically, the tire is as follows.
Number of inclined portions of a conductive portion in a land portion: one
Direction of inclination of an inclined portion arranged at an outermost side in a tire diametrical direction: same as the example 1
Direction of inclination of an inclined portion arranged at an innermost side in a tire diametrical direction: same as the example 1
Land portion where conductive portions are to be arranged: same as the example 1

### <Results of Evaluation>

In the comparative example 1, the steering stability performance can not be improved. Further, in the comparative example 2, the steering stability performance can not be improved very much. On the contrary, in the examples 1 to 3, the steering stability performance can be sufficiently improved.

Further, a description will be given below of a more preferable example of the tire.

First of all, the tire according to the example 1 is structured such that the inclined portion 12c arranged at the innermost side in the tire diametrical direction is arranged so as to be inclined from the inner side toward the outer side in the tire width direction as the inclined portion 12c goes from the inner side to the outer side in the tire diametrical direction, in the conductive portion 12 arranged in the outer region which is the outer side at the time of mount to the vehicle (the mediate land portion 9c in the outer side of the vehicle). On the contrary, the tire according to the example 2 is structured such that the inclined portion 12b arranged at the innermost side in the tire diametrical direction is inclined from the outer side toward the inner side in the tire width direction as the inclined portion 12b goes from the inner side to the outer side in the tire diametrical direction, in the conductive portion 12 arranged in the outer region (the mediate land portion 9c at the outer side of the vehicle).

Further, the steering stability performance can be sufficiently improved in the tire according the example 2; however, the steering stability performance can be improved very effectively in the tire according to the example 1. As a result, in the tire, the inclined portion 12c arranged at the innermost side in the tire diametrical direction is preferably structured such as to be arranged so as to be inclined from the inner side toward the outer side in the tire width direction as the inclined portion 12c goes from the inner side to the outer side in the tire diametrical direction, in the conductive portion 12 arranged in the outer region which is the outer side at the time of mount to the vehicle.

Further, the tire according to the example 1 is structured such that the conductive portion 12 is arranged at both mediate land portions 9b and 9c. On the contrary, the tire according to the example 3 is structured such that the conductive portion 12 is arranged at both sides of the center land portion 9a.

Further, the steering stability performance can be sufficiently improved in the tire according to the example 3; however, the steering stability performance can be improved very effectively in the tire according to the example 1. As a result, the tire is preferably structured such that four main grooves 8 are provided in the tread rubber 6, and the conductive portion 12 is arranged at least in the land portion 9c which is adjacent inside in the tire width direction in relation to the main groove 8d arranged at the outermost side at the time of mount to the vehicle, among a plurality of land portions 9.

### DESCRIPTION OF REFERENCE NUMERALS

1 pneumatic tire
2 bead portion
3 side wall portion
4 tread portion
5 carcass layer
6 tread rubber
7 belt layer
8 main groove
8a, 8b center main groove
8c, 8d shoulder main groove
9 land portion
9a center land portion
9b, 9c mediate land portion
9d, 9e shoulder land portion
10 tread bottom portion
10a connection portion
11 non-conductive portion
12 conductive portion
12a first inclined portion
12b second inclined portion
12c third inclined portion
21 bead
22 rim strip rubber
31 side wall rubber
61 first rubber ribbon
62 second rubber ribbon
62a non-conductive rubber
62b conductive rubber
71 belt ply
72 belt ply
100 rim
200 conductive route portion
S1 tire equatorial plan
S2 road surface

What is claimed is:

1. A pneumatic tire comprising:
a tread rubber,
the tread rubber having a plurality of main grooves which extend along a tire peripheral direction,
wherein the tread rubber comprises land portions which are partitioned by the main grooves,
wherein the land portion comprises a non-conductive portion which is formed by a non-conductive rubber, and a conductive portion which is formed by a conductive rubber,
wherein a rubber hardness of the conductive portion is greater than a rubber hardness of the non-conductive portion,
wherein the conductive portion is formed from an inner end portion toward an outer end portion in a tire diametrical direction of the land portion by continuing a plurality of inclined portions which are inclined in relation to the tire diametrical direction, and at least one conductive portion is arranged in an outer region which is an outer side at the time of mount to a vehicle, and
wherein the inclined portion arranged at an outermost side in the tire diametrical direction is arranged so as to be inclined from an inner side toward an outer side in a tire width direction as the inclined portion goes from an inner side to an outer side in the tire diametrical direction, in the conductive portion arranged in the outer region.

2. The pneumatic tire according to claim 1, wherein the inclined portion arranged at an innermost side in the tire diametrical direction is arranged so as to be inclined from the inner side toward the outer side in the tire width direction as the inclined portion goes from the inner side to the outer side in the tire diametrical direction, in the conductive portion arranged in the outer region.

3. The pneumatic tire according to claim 1, wherein the conductive portion is arranged at both sides in the tire width direction of the tread rubber, and
wherein the inclined portion arranged at the outermost side in the tire diametrical direction is arranged so as to be inclined from the inner side toward the outer side in the tire width direction as the inclined portion goes from the inner side to the outer side in the tire diametrical direction, in each of the conductive portions.

4. The pneumatic tire according to claim 1, wherein four main grooves are provided in the tread rubber, and
wherein the conductive portion is arranged at least in the land portion which is adjacent inside in the tire width direction in relation to the main groove arranged at the outermost side at the time of mount to the vehicle, among a plurality of land portions.
